(19) United States
(12) Patent Application Publication
(10) Pub. No.: US 2008/0300921 A1
(43) Pub. Date: Dec. 4, 2008

(54) METHOD FOR RAPID TRACKING OF TRAUMA VICTIMS

(76) Inventor: Martha E. Carlton, Livonia, MI (US)

Correspondence Address: MILLER, CANFIELD, PADDOCK AND STONE P.L.C.;C/O ROBERT KELLEY ROTH, SUITE 2500, 150 WEST JEFFERSON AVE., DETROIT, MI, 48226, US

(21) Appl. No.: 12/132,668

(22) Filed: Jun. 4, 2008

Related U.S. Application Data
(60) Provisional application No. 60/941,795, filed on Jun. 4, 2007.

(51) Int. Cl. G06Q 50/00

(52) U.S. Cl. 705/2

(57) ABSTRACT

A method for rapid identification and treatment of a group of trauma victims at an initial location comprises the steps of attaching a wristband containing machine readable information to each victim of the group, wherein the information comprises both patient information and first responder information, wherein the patient information comprises personal identifier information about the patient, and the first responder information comprises information about a first responder to the trauma victim, and uploading the information on the wristband into a database. Such trauma victim information may be uploaded into a government disaster database. The data in the database may be used to track and develop statistics, trends and movement of the victims.

### RELATED APPLICATION

This application claims priority benefit of U.S. provisional patent application No. 60/941,795 filed on Jun. 4, 2007.

### FIELD OF THE INVENTION

This invention relates to improvements in tracking of trauma victims, and more particularly to improved methods for tracking such trauma victims with information which is portable with the patient.

### BACKGROUND OF THE INVENTION

Trauma victims can arise as result of an accident or disaster, such as an airplane crash, explosion, or traffic accident where large numbers of people are involved. Treatment of large numbers of such trauma victims places great strain on medical facilities, including hospitals, emergency personnel, local police, etc. Known techniques for processing trauma victims included handwriting information on wristbands and attaching the wristband to the patient/trauma victim. This wristband information was then used to help register patients/trauma victims at a hospital or ambulatory surgical facility. Other techniques for tracking trauma victims are more elaborate, such as those disclosed in U.S. Pat. No. 6,305,605 to Goetz et al, where a machine readable tag is provided to patients and the information electronically scanned and stored. However, hospitals will not accept patients with wristbands prepared from outside their admission, discharge and transfer or patient systems. It would be desirable to provide a method for quick, efficient and low cost identification of trauma victims which can be implemented during times of great on resources.

### SUMMARY OF THE INVENTION

In accordance with a first aspect, a method for rapid identification and treatment of a group of trauma victims at an initial location comprises the steps of attaching a wristband containing machine readable information to each victim of the group, wherein the information comprises both patient information and first responder information, wherein the patient information comprises personal identifier information about the patient, and the first responder information comprises information about a first responder to the trauma victim, and uploading the information on the wristband into a database. Such trauma victim information may be uploaded into a government disaster database. The data in the database may be used to track and develop statistics, trends and movement of the victims.

From the foregoing disclosure and the following more detailed description of various preferred embodiments it will be apparent to those skilled in the art that the present invention provides a significant advance in the technology of methods for tracking trauma victims. Particularly significant in this regard is the potential the invention affords for providing a high quality, low cost method for rapid and efficient tracking of trauma victims. Additional features and advantages of various preferred embodiments will be better understood in view of the detailed description provided below.

### BRIEF DESCRIPTION OF THE DRAWINGS

FIG. 1 is a flow chart in accordance with a preferred embodiment where the first several steps of a method of rapidly tracking trauma victims is disclosed.

FIG. 2 lists some of the steps of a medical facility such as a hospital uses to create identifying wristbands.

FIG. 3 expands upon the flow chart of FIG. 1, showing the steps of creating matching wristbands and labels to include a generic trauma patient identification and a universal identification specific to an initial care provider/first responder such as an emergency management service (EMS) vehicle.

FIG. 4 expands the flow chart of FIG. 1, showing the steps that occur when the medical facility/hospital pre-stocks wristbands.

FIG. 5 continues the flow chart of FIG. 1, showing the steps taken when the victim is deceased.

It should be understood that the appended drawings are not necessarily to scale, presenting a somewhat simplified representation of various preferred features illustrative of the basic principles of the invention. The specific design features of the method for rapid tracking of trauma victims as disclosed here will be determined in part by the particular intended application and use environment.

### DETAILED DESCRIPTION OF THE PREFERRED EMBODIMENTS

It will be apparent to those skilled in the art, that is, to those who have knowledge or experience in this area of technology, that many uses and application variations are possible for the method of tracking trauma victims disclosed here. The following detailed discussion of various alternative and preferred features and embodiments will illustrate the general principles of the invention with reference to a method for rapid tracking of trauma victims, such as may occur during a natural disaster. Other embodiments suitable for other applications will be apparent to those skilled in the art given the benefit of this disclosure.

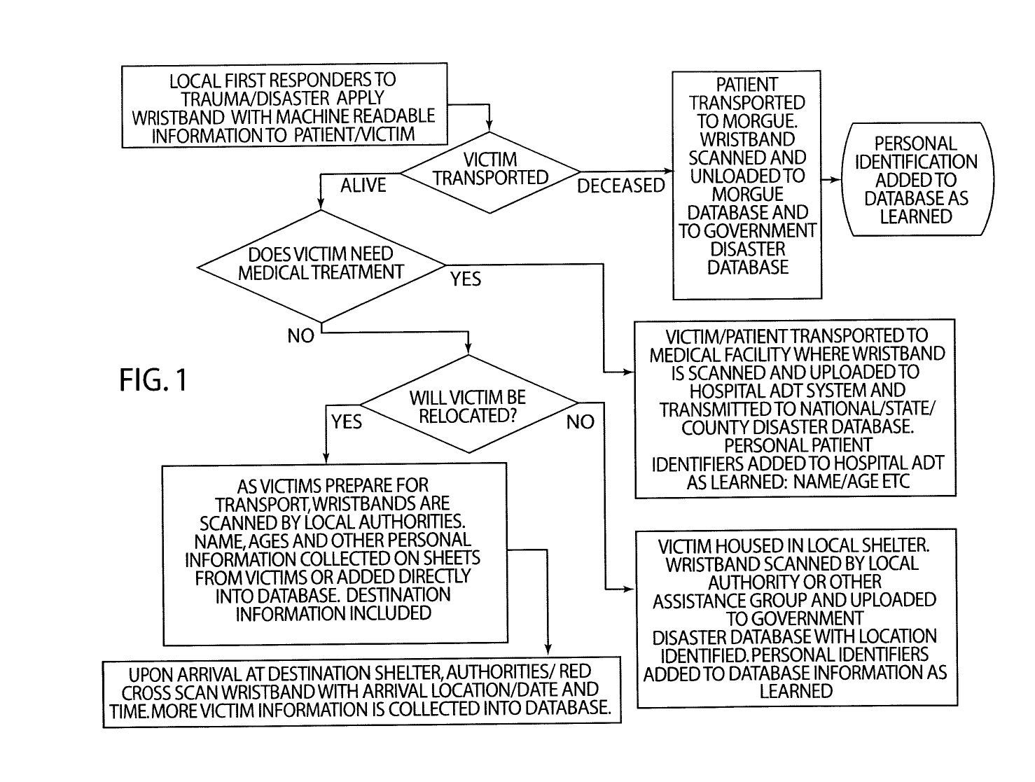

Turning now to the drawings, FIG. 1 shows a process for rapid tracking of trauma victims. First responders, such as EMS, police, hospital emergency rooms, etc., apply a wristband containing machine readable information to a group of trauma victims. The victim is then transported to a morgue or to a hospital, depending on whether the victim is alive. If the victim is deceased and transported to a morgue, the wristband may be scanned and the information transmitted to a morgue database and to a government (national, state, or local) disaster database. If the victim is alive, a next step can be determining whether the victim needs medical treatment. If yes, then the victim is a transported to an appropriate medical facility where the wristband is scanned and the information uploaded to the medical facility's Admissions/Discharge/Transfer (ADT) patient database system. The information may also be transmitted to a government (national, state, or local) disaster database. Information provided by the first responder may include location information (the location of the traumatic event; where the trauma victims are located), as well as destination information—where the trauma victim is going to be sent to.

If the victim does not need to be re-located, he may be housed in a local shelter. At the local shelter his wristband may be scanned by a local authority, such as a government agency or charitable organization (Salvation Army, Red Cross, etc.) The information on the wristband may be transmitted along with destination information identifying the location of the local shelter (that is, the destination of the trauma victim) to a government (national, state, or local) disaster database. The destination information may also be transmitted with victims at the morgue or patients at a medical facility. Given that during a trauma event, a local medical facility may be overwhelmed, it may be necessary to transport trauma victims. In this case, the trauma victims are prepared for transport in part by having their wristbands scanned by a local authority. The information transmitted to the ADT system or any other database can include not only the information on the wristband, but also personal identifier information (names, ages, medical conditions, other information provided by the trauma victim), destination information, and arrival information as well. Upon arrival at the destination shelter, the local authority can scan the wristband. Information on the wristband may be transmitted to a database, along with additional personal identifier information, and arrival location and date information. The arrival location and date information can be cross checked with the previously entered destination information.

Personal identification information on a non-system wristband, either with or without location, arrival and destination information is not sufficient for a hospital ADT system to admit a patient. Therefore, in accordance with a highly advantageous feature, medical facilities such as hospitals, ambulatory surgical facilities, disaster command centers, city emergency management departments and other public service agencies may order wristbands pre-programmed with information such as a universal identification code corresponding to an initial care provider/first responder. This code is preferably loadable onto the disaster database. The disaster database may preferably be searchable to help officials access information. Preferably the wristbands are sequentially numbered. Pre-programming of first responder data about a trauma patient into a patient wristband may be accomplished using suitable technology, such as, for example, bar coding, 2D bar coding, RFID, holograms or magnetic strip, or other machine readable technology.

The information may be uploaded into the patient database. In this method for rapid identification and tracking of trauma/disaster victims, all first responders would be assigned a unique code, such as, for example, a Health Level 7 international healthcare standard code (HL7 facility), or other similar hospital or medical interface between programs by a federal regulatory agency. HL7 and its members provide a framework (and related standards) for the exchange, integration, sharing and retrieval of electronic health information. The HL7 standards support clinical practice and the management, delivery, and evaluation of health standards.

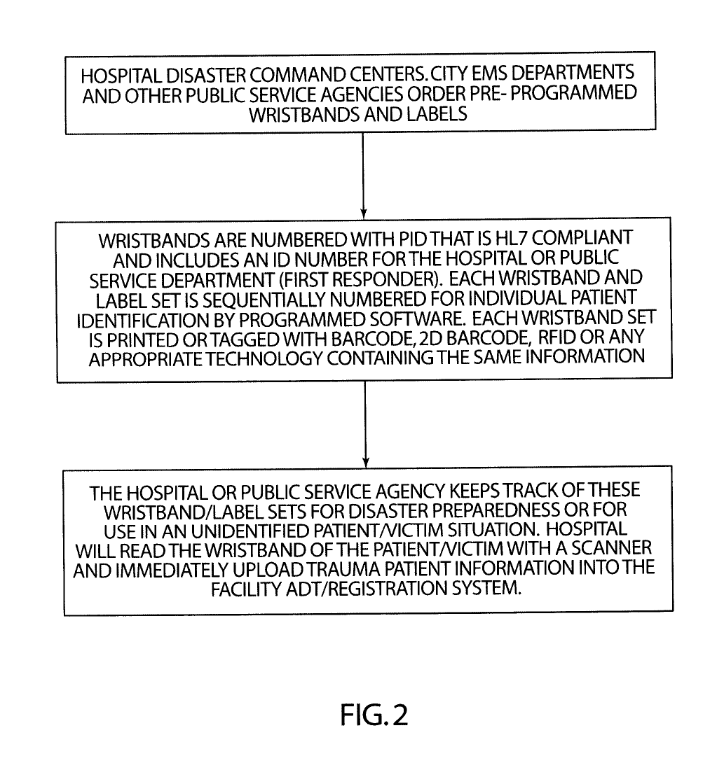

As noted in FIG. 2, hospitals, disaster command centers, city EMS departments and other public service agencies may order wristbands pre-programmed. The pre-programmed and printed wristbands with labels may be created with a “John Doe” (unknown patient)/trauma patient identifier and with a first responder identifier that identifies the first responder (EMS, police, hospital emergency room, etc.) The combination of a pair of identifiers is highly advantageous in that a medical facility such as a hospital will admit a trauma victim into its ADT system with this combination of data in the information contained in the wristband. When the wristband is scanned and uploaded into the hospital ADT system, a patient registration is immediately created. The patient will have a unique identifier which will allow immediate treatment by physicians, nurses, pharmacy, lab, radiology and other ancillary departments. The medical facility/hospital or public agency can preferably keep a stock of these wristbands for disaster preparedness or for use in an unidentified patient/trauma victim situation. Upon the arrival of the trauma victim/patient at the hospital, the information on the wristband may be scanned into the facility ADT system.

Preferably the identity of the first responder will also remain with the patient record. This combination of identifiers in the information contained on the wristband provides a suggested convention for patient identifiers storage and transmission between various sources and state regulatory agencies. The HL7 standards can specify HL7 messages such as Admission and Discharge messages to communicate episode details to external applications/databases. Episode details can comprise, for example an Emergency episode start sent as an HL7 Admit Patient message; updates to an emergency episode detail sent as HL7 Update message including, for example, triage date/time seen by doctor/nurse, presenting complaint, procedures and interventions, diagnosis; and when the patient is discharged from emergency sending a HL7 discharge message. The Emergency episode start event is intended to be used for admitted patients only (patients previously entered into the ADT system). Such an event is sent as a result of a patient undergoing the admission process which assigns the patient to a bed. It signals the beginning of a patient's stay in the medical facility. Normally, this information is entered in the system and can then be broadcast to nursing units and to ancillary systems. It can include short stay and John Doe admissions. For example, this event can be used to notify the pharmacy system that a patient has been admitted and may be legitimately prescribed drugs; to notify a nurse that the patient has been admitted and needs a care plan prepared; to notify a financial system of the medical facility for billing purposes; to notify a dietary system that a new patient has been installed and requires dietary services; to notify a laboratory, pathology, and/or radiology units that a patient has been admitted and is entitled to receive services; and/or to notify a clinical repository that an admission has taken place.

An HL7 message consists of a message type, a message event and a message structure. The HL7 message type is a unique identifier for the business purpose of a message. Every message must contain a message type id as way to announce the purpose of the message. For example, ADT messages can have a unique message ID to Patient Administration of a given hospital. One message type can have more than one message structure. The message type is advertised in the message header segment. The message event, sometimes called a trigger, is a unique identifier to the context in which message is generated. The message event consists of an upper case letter and two digits. For example, A01 can be used for admission/visit notification and A61 can be used for changing a consulting doctor. Both A01 and A61 are used with ADT messages. The message event type is advertised in the message header segment. The message structure is a data structure used to express an association of a message type with an event for a class of messages. Each message structure also contains a unique ID. The message structure structurally consists of a well-defined list of HL7 segments. Segments can be optional, and can repeat.

Most HL7 messages routinely populate ID and identifier type code. Medical facilities that use a check digit also populate check digit and code identifying the check digit scheme used. Occasionally the component assigning authority or assigning facility will be populated in a multi system facility. HL7 messages within a hospital environment can use the degenerate form of patient identifier (ID+identifier type code) because within the hospital these two values form a unique key. The identifier type code is understood to imply the only system that generates that type of code, and the ID itself is therefore unique. Most state and federal regulatory agencies have a coding system they use to identify the clinics and hospitals from which they collect information. This facility code plus the normal patient identifier information in the HL7 message uniquely identifies the patient.

Since each regulatory agency uses a different coding scheme for facilities, it is important to add a universal identifier for each agency to identify which regulatory agency's coding scheme is being used to identify the facility. The universal identifier for each agency can be, for example, an ISO object identifier of the format 2.16.840.X.X.X.

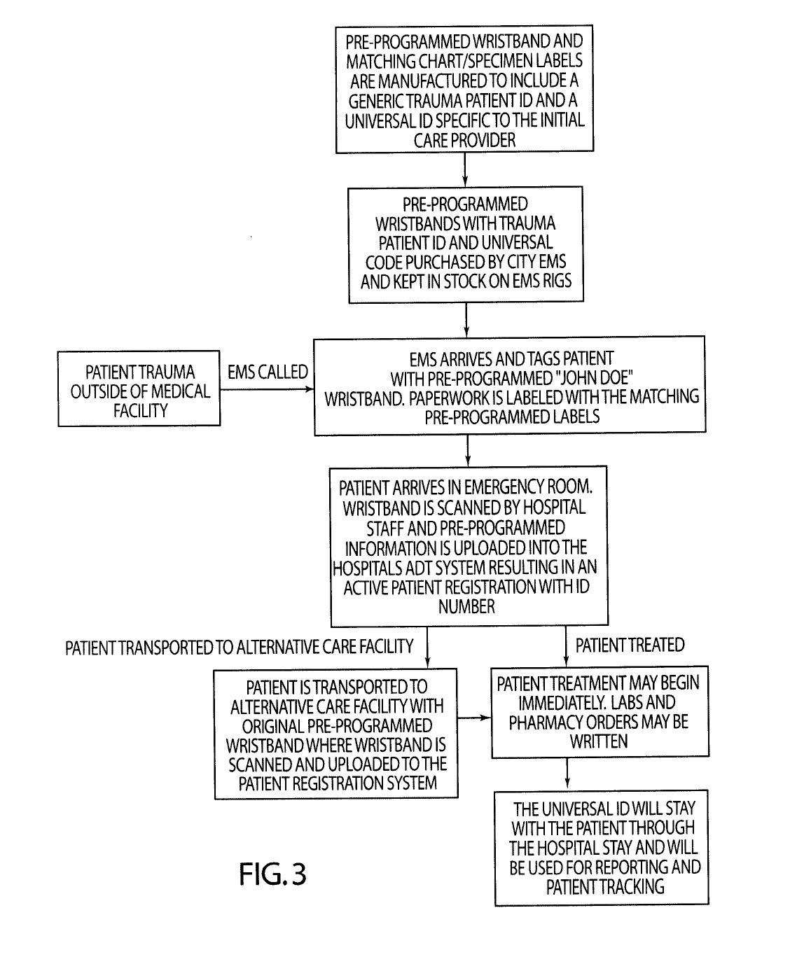

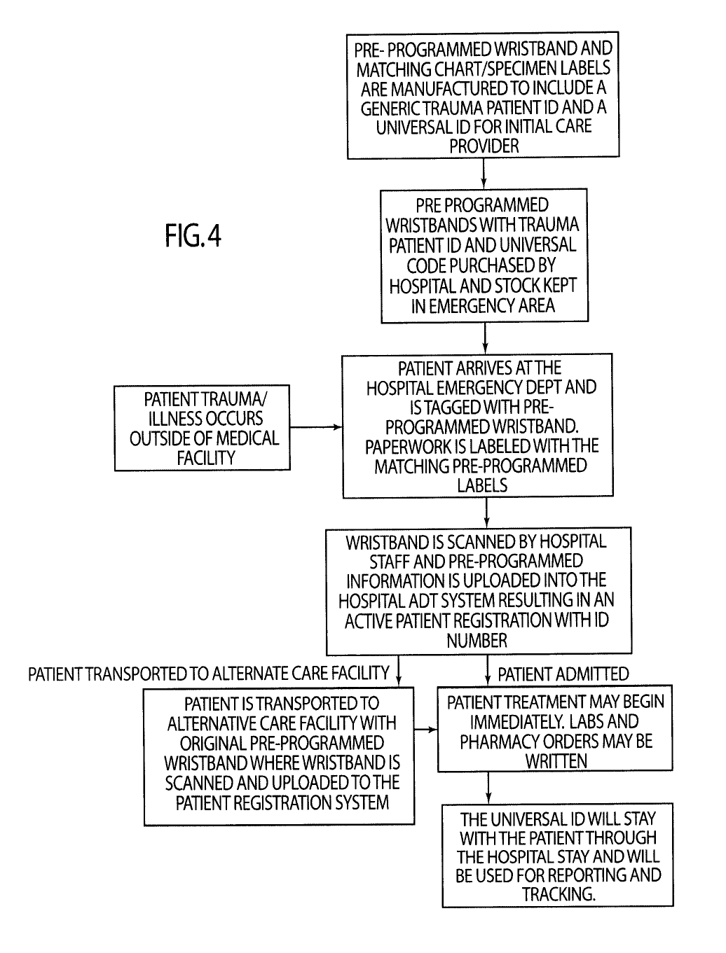

FIG. 3 expands upon the flow chart of FIG. 1, showing the steps of creating matching wristbands and labels to include information corresponding to a generic trauma patient identification and to a universal identification specific to an initial care provider/first responder such as an emergency management service (EMS) vehicle. The wristbands are manufactured and supplied to the city EMS. The wristbands are kept in stock on the EMS vehicles. When a trauma event occurs, the EMS vehicle arrives with pre-programmed wristbands which they attach to the trauma victims. Once the trauma victim/patient arrives in an emergency room, the wristband is scanned, the information is uploaded to the database (here, a hospital ADT system). The result is the patient is admitted to the ADT system and assigned an active patient registration with an ID number. Since the patient is on the system, patient treatment may commence, including, for example, running lab tests and making pharmacy orders. The active patient registration status continues to apply to the patient during his hospital stay. In a similar manner, if the patient needs to be transferred to another medical facility, the wristband may be scanned at that facility and patient identification information along with first responder information (and optionally travel/location/destination information) may all be uploaded to the remote medical facility's database. FIG. 4 is similar to FIG. 3, but here a hospital purchases pre-programmed wristbands and keeps them stocked at the hospital.

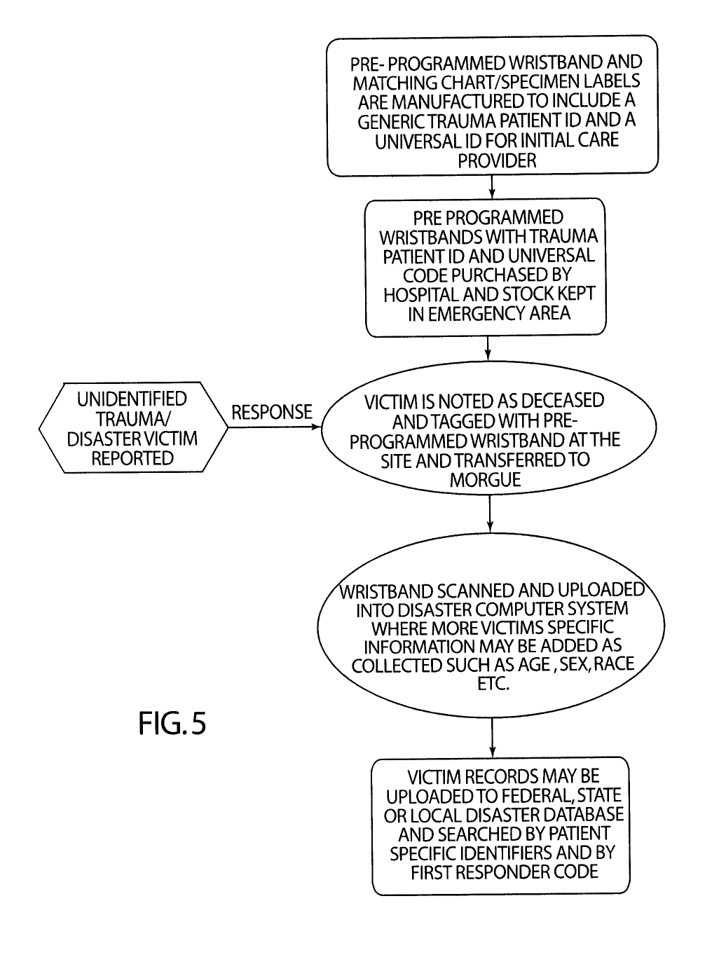

FIG. 5 shows a flow chart of the process where pre-programmed wristbands or tags are purchased by a disaster response team and then applied to deceased trauma victims. The victim is noted as deceased, tagged with the appropriate wristband and transferred to the morgue. At the morgue the wristband is scanned and uploaded into a disaster computer system where more specific victim information may be added, including, for example, age, sex, race, etc. Such victim information may then be uploaded to a searchable government database.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method for rapid identification and treatment of a group of trauma victims at an initial location comprises, in combination, the steps of:
attaching a wristband containing machine readable information to each victim of the group, wherein the information comprises both patient information and first responder information, wherein the patient information comprises personal identifier information about the patient, and the first responder information comprises information about a first responder to the trauma victim; and
uploading the information on the wristband into a database.

2. The method of claim 1 wherein the database comprises one of a first responder database, a medical facility admission/discharge/transfer patient system and a government disaster database.

3. The method of claim 2 wherein the database is searchable.

4. The method of claim 1 wherein the wristband information is programmable onto the wristband using a machine readable technology.

5. The method of claim 4 wherein the machine readable technology comprises one of bar coding, 2D bar coding, RFID, holograms and magnetic strips.

6. The method of claim 1 further comprising adding at least one of location and destination information to the wristband, wherein location information comprises information about the initial location of the trauma victims, and the destination information comprises information about a destination the trauma victim is to be sent to.

7. The method of claim 6 wherein the location information and destination information is added by the first responder and the wristband information is uploaded to the database at the destination.

8. The method of claim 6 further comprising uploading trauma victim information into a government disaster database, and uploading trauma victim information upon arrival at the destination.

9. The method of claim 8 further comprising arrival information, wherein arrival information comprises a destination and a date of arrival, wherein arrival information can be cross checked with the previously entered destination information.
